(19) United States
(12) Patent Application Publication
(10) Pub. No.: US 2017/0251591 A1
(43) Pub. Date: Sep. 7, 2017

(54) SEED TUBE MOUNTING BRACKET

(71) Applicant: A & A NIELSEN FARMS, INC., Minden, NE (US)

(72) Inventor: Anson Nielsen, Minden, NE (US)

(21) Appl. No.: 15/444,868

(22) Filed: Feb. 28, 2017

Related U.S. Application Data
(60) Provisional application No. 62/301,835, filed on Mar. 1, 2016.

(51) Int. Cl. A01C 7/20

(52) U.S. Cl. CPC A01C 7/201; A01C 7/206

(57) ABSTRACT

A seed tube mounting bracket is provided. The seed tube mounting bracket may be adjustable to connect a seed tube to various seed planters. The seed tube mounting bracket may include an elongated body including opposing first and second ends defining a longitudinal length of the body, first and second attachment members connected to the body substantially transverse to the longitudinal length, and an adjustment mechanism associated with the body to adjust an effective length of the mounting bracket, such that the mounting bracket may be attached to frame rails of various sizes.

### CROSS REFERENCE TO RELATED APPLICATIONS

This application claims the benefit of U.S. Provisional Patent Application No. 62/301,835 filed Mar. 1, 2016 entitled “SEED TUBE MOUNTING BRACKET,” which is hereby incorporated herein by reference in its entirety.

### TECHNICAL FIELD

The present disclosure relates generally to agricultural seed planters, and more specifically to a seed tube mounting bracket for a seed planter.

### BACKGROUND

Multi-row planters are typically used for agricultural seed planting. Often, each planter includes a plurality of row units adapted for opening a seed furrow, depositing seeds within the furrow, and closing the furrow around the seeds. Each row unit may include a seed tube that directs seeds into the seed furrow before the row unit closes the furrow around the seeds. Some seed tubes include sensors to sense the amount of seeds being deposited into the furrow and provide other valuable feedback to a user during planting operations. These seed tubes, as well as other types, are often more desirable than others. However, the seed tubes may be designed to attach to only one type of planter, such as to the row units of only one manufacturer.

### BRIEF SUMMARY

The present disclosure generally provides a seed tube mounting bracket that offers improvements or an alternative to existing arrangements. The mounting bracket may be operable to attach a seed tube to a seed planter. In a preferred embodiment, the mounting bracket is operable to attach a seed tube to a previously incompatible planter, such as a seed tube of one manufacturer to a planter of a different manufacturer.

This summary of the disclosure is given to aid understanding, and one of skill in the art will understand that each of the various aspects and features of the disclosure may advantageously be used separately in some instances, or in combination with other aspects and features of the disclosure in other instances. Accordingly, while the disclosure is presented in terms of embodiments, it should be appreciated that individual aspects of any embodiment can be claimed separately or in combination with aspects and features of that embodiment or any other embodiment. The present disclosure of certain embodiments is merely exemplary in nature and is in no way intended to limit the claimed invention or its applications or uses. It is to be understood that other embodiments may be utilized and that structural and/or logical changes may be made without departing from the spirit and scope of the present disclosure.

The present disclosure is set forth in various levels of detail in this application and no limitation as to the scope of the claimed subject matter is intended by either the inclusion or non-inclusion of elements, components, or the like, in this summary. In certain instances, details that are not necessary for an understanding of the disclosure or that render other details difficult to perceive may have been omitted. Moreover, for the purposes of clarity, detailed descriptions of certain features will not be discussed when they would be apparent to those with skill in the art so as not to obscure the description of the present disclosure. It should be understood that the claimed subject matter is not necessarily limited to the particular embodiments or arrangements illustrated herein, and the scope of the present disclosure is defined only by the appended claims.

### BRIEF DESCRIPTION OF THE DRAWINGS

The accompanying drawings, which are incorporated into and constitute a part of the specification, illustrate embodiments of the present disclosure by way of illustration only and, together with the general description above and the detailed description below, serve to explain the principles of the present disclosure.

FIG. 1 is a front perspective view of a seed tube mounting bracket in accordance with an embodiment of the present disclosure.

FIG. 2 is a rear perspective view of the seed tube mounting bracket of FIG. 1 in accordance with an embodiment of the present disclosure.

FIG. 3 is a right side perspective view of the seed tube mounting bracket of FIG. 1 in accordance with an embodiment of the present disclosure.

FIG. 4 is a left side perspective view of the seed tube mounting bracket of FIG. 1 in accordance with an embodiment of the present disclosure.

FIG. 5 is a perspective view of the seed tube mounting bracket of FIG. 1 coupled with a seed tube in accordance with an embodiment of the present disclosure.

FIG. 6 is an enlarged, fragmentary perspective view of FIG. 5 in accordance with an embodiment of the present disclosure.

FIG. 7 is a fragmentary, perspective view of the seed tube mounting bracket of FIG. 1 and the seed tube of FIG. 5 connected to a seed planter in accordance with an embodiment of the present disclosure.

FIG. 8 is another fragmentary perspective view of the seed tube mounting bracket of FIG. 1 and the seed tube of FIG. 5 connected to a seed planter in accordance with an embodiment of the present disclosure.

FIG. 9 is another fragmentary perspective view of the seed tube mounting bracket of FIG. 1 and the seed tube of FIG. 5 connected to a seed planter in accordance with an embodiment of the present disclosure.

FIG. 10 is a fragmentary top perspective view of the seed tube mounting bracket of FIG. 1 and the seed tube of FIG. 5 connected to a seed planter in accordance with an embodiment of the present disclosure.

### DETAILED DESCRIPTION

The present disclosure relates generally to a universal mounting bracket for coupling seed tubes to unmatched planters, such as planters manufactured by different companies or different models by the same manufacturer. The mounting bracket couples to the seed tube and connects the seed tube to a frame rail of an agricultural seed planter. In one embodiment, the mounting bracket is adjustable such that the mounting bracket can be connected to frame rails of various dimensions and types, such as frame rails of variously manufactured seed planters. In this manner, a user can attach a seed tube of one manufacturer to a planter of a different manufacturer, which may be desirable depending on user preference for, and/or the desirable features of, a particular seed tube. In other words, the mounting bracket translates the connection mechanism of a seed tube to allow the seed tube to mate with and connect to different, non-matched components. This allows a user to more easily adopt new technology with certain planter accessories, such as seed tubes, to older, out-of-date planters that are typically very expensive to replace and thus have much longer lifespans than corresponding accessories. As one example, the mounting bracket allows a user to connect the seed tube to a previously incompatible seed planter, such as connecting a seed tube of one manufacturer to a seed planter of a different manufacturer. In this manner, a user can customize the characteristics of the seed planter, such as attaching a seed tube of particularly desirable qualities and/or characteristics to the seed planter based on user preference and/or desires.

The mounting bracket in one embodiment includes a support body 120 having two connecting mechanisms for securing the seed tube to the planter and an adjustment mechanism that varies the length of the mounting bracket to attach the bracket to frame rails of different dimensions or to different components of the particular planter. The mounting bracket creates a proper attachment of the seed tube to the planter during seeding operations, even though the seed tube may be incompatible with the planter. As one example, the mounting bracket positions the seed tube in proper alignment with other components of the planter, such as a seed meter, to facilitate proper operation of the planter and seed tube to deposit seeds in the desired locations. The mounting bracket may also permit necessary movement of the seed tube during seeding operations, such as to account for movement of the planter while seeding on uneven terrain or in variable soil conditions. The mounting bracket may be universal to connect various seed tubes to various seed planters or may be customized to connect one type or model of seed tube to one type or model of planter, as explained more fully below.

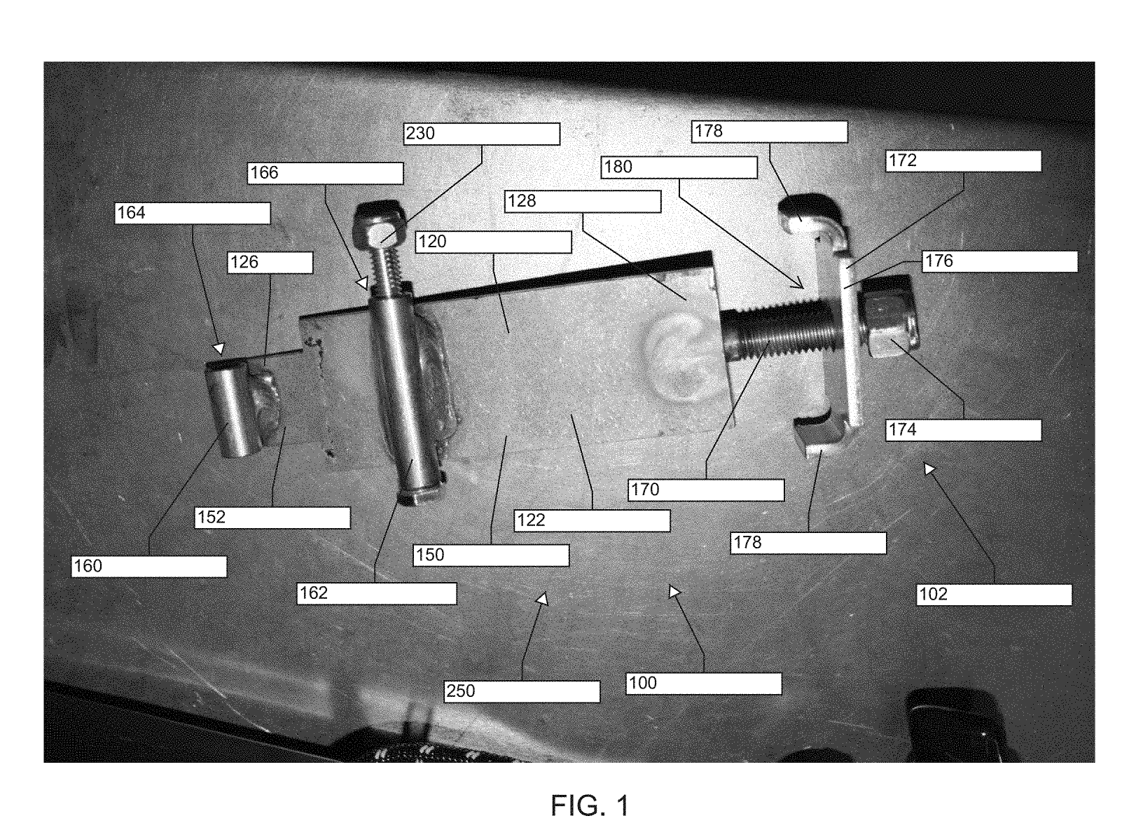

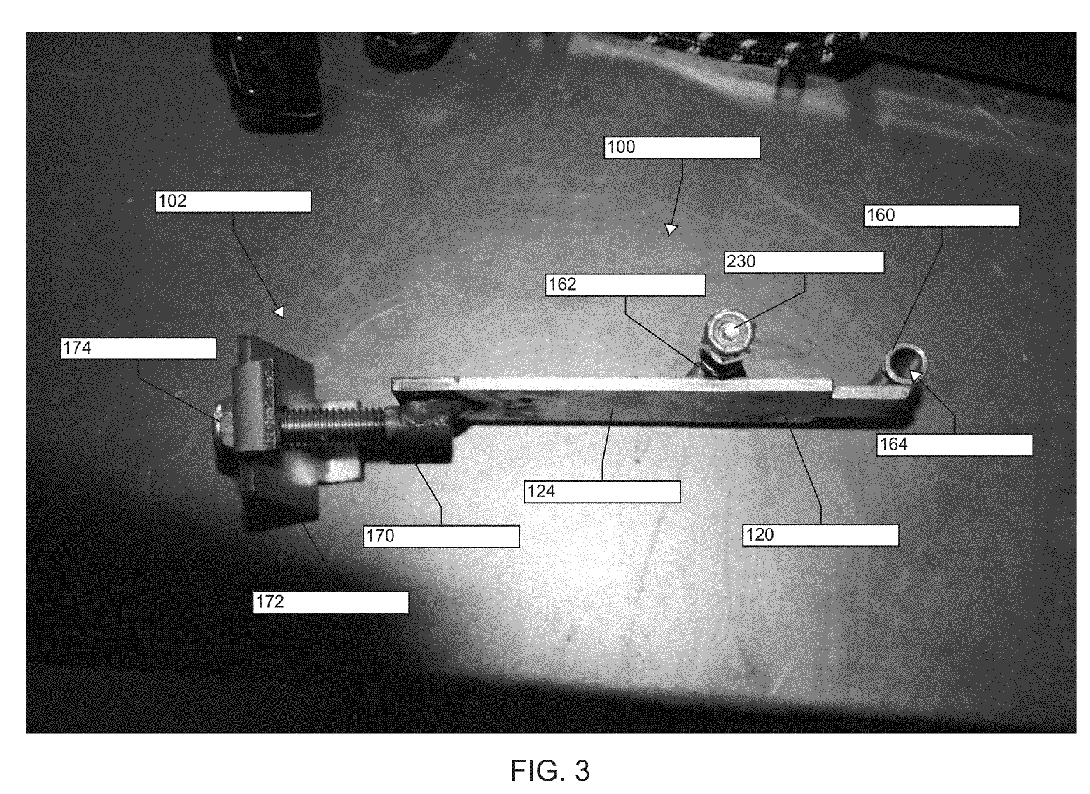

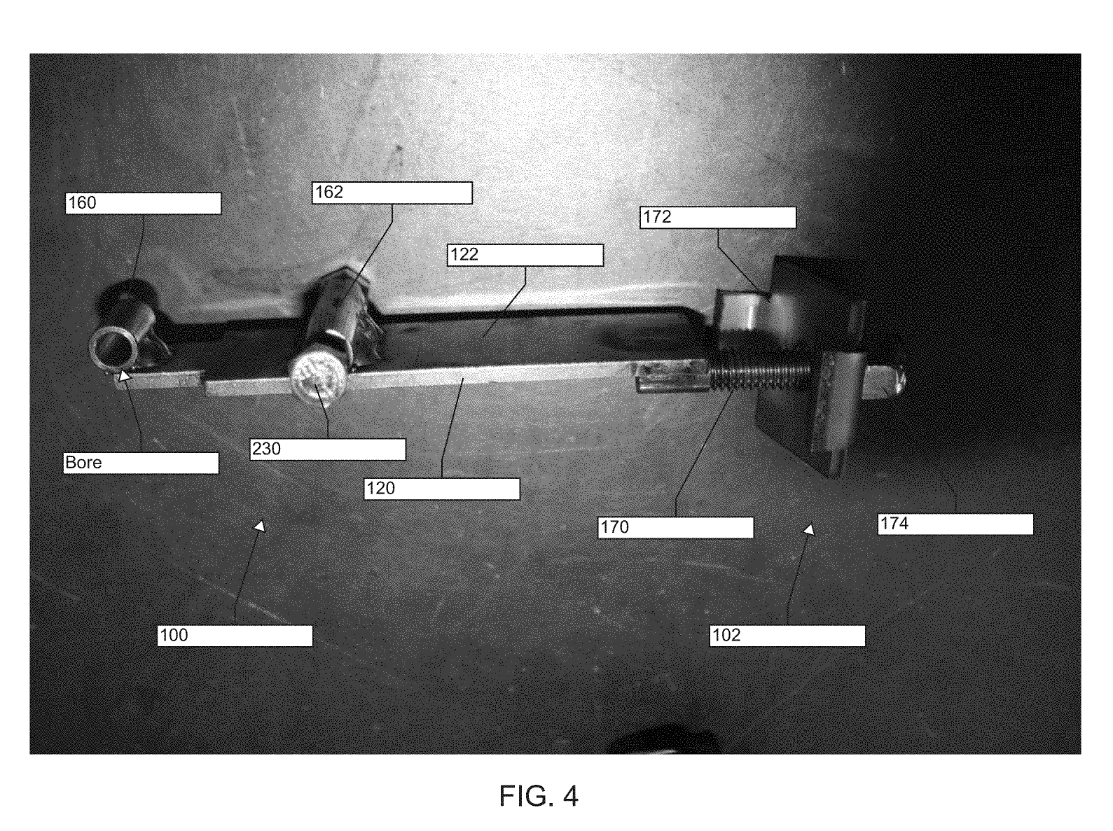

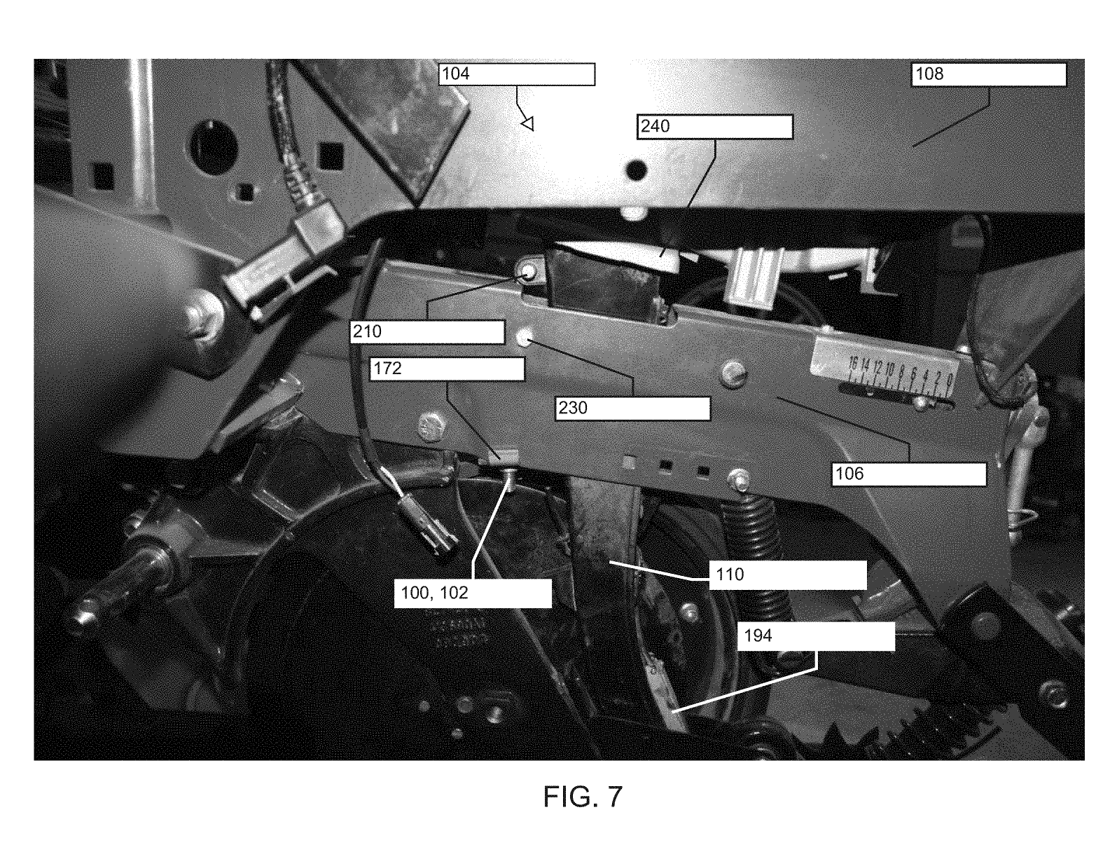

FIGS. 1-4 illustrate an exemplary embodiment of a seed tube mounting bracket 100, including an adjustment mechanism 102 that operates to provide a variable attachment dimension of the mounting bracket 100. As detailed below, the adjustment mechanism 102 adjusts an effective length, such as an overall length or a mounting length, of the mounting bracket 100 such that the mounting bracket 100 may be connected to a seed planter 104, which may be a multi-row seed planter. For example, the mounting bracket 100 may be connected to a frame rail 106 of a row unit 108 of the seed planter 104 irrespective of the particular size of the frame rail 106. In this manner, the mounting bracket 100 may be connected to frame rails 106 of various dimensions, such as heights and/or widths. In one embodiment, the mounting bracket 100 connects a seed tube 110 to the frame rail 106 of the seed planter 104 (see FIG. 7, for instance).

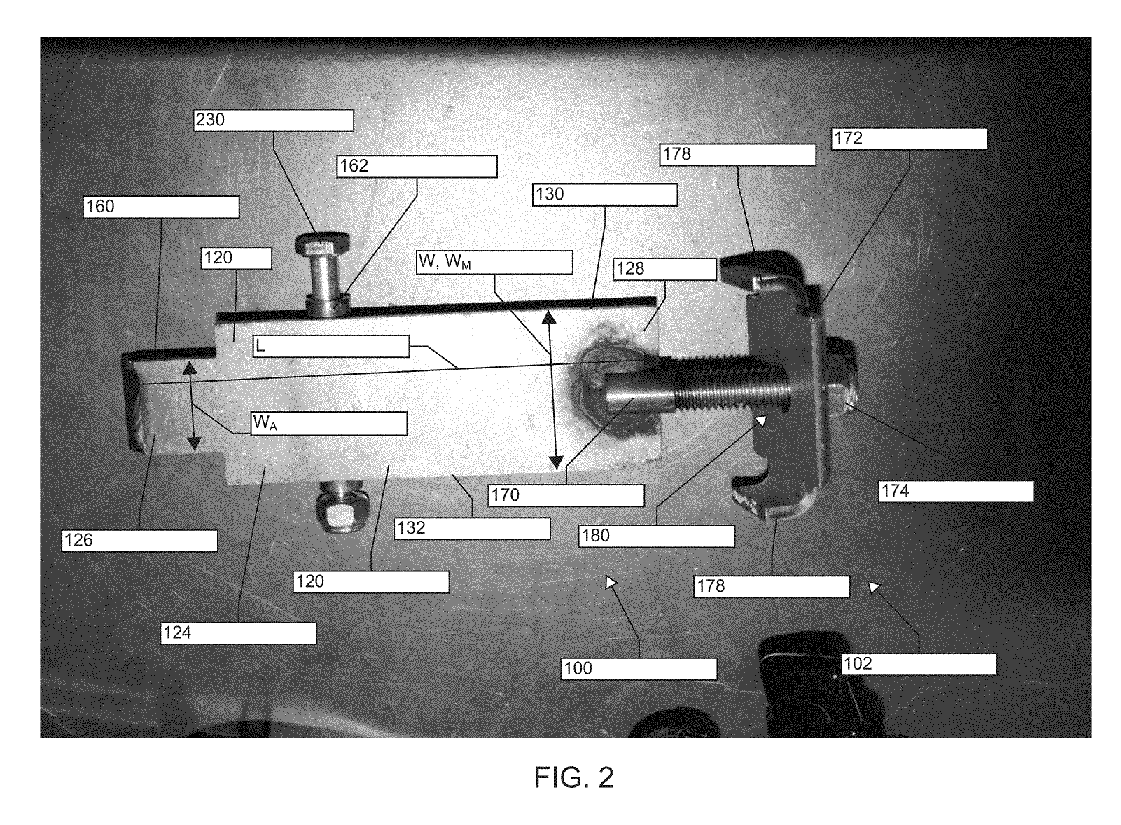

As illustrated in at least FIGS. 1-4, the mounting bracket 100 may include a support body 120 associated with the adjustment mechanism 102. The support body 120, which may be referred to as a body member or a frame, may include a front face 122 (see FIG. 1), a rear face 124 (see FIG. 2), opposing first and second ends 126, 128, and opposing first and second longitudinal edge 130, 132 (see FIG. 2). The support body 120 may be shaped polygonally, such as square or rectangular (or in a variety of other manners), and includes a longitudinal length L and a transverse width W (see FIG. 2). As shown, the longitudinal length L of the support body 120 is defined between its first and second ends 126, 128. In such embodiments, the transverse width W of the support body 120 is defined between its first and second longitudinal edge 130, 132. In some embodiments, the support body 120 may be elongated such that its length is greater than its width.

In some embodiments, the support body 120 may include a main body 150 and an appendage body 152 connected to (or formed integrally with) the main body 150. The main body 150 and the appendage body 152, which may be referred to as first and second body portions, respectively, may include respective widths W_{M}, W_{A}, which may be referred to as first and second widths, respectively, transverse to the longitudinal length L of the support body 120 (see FIG. 2). In one embodiment, the main body 150 may be wider than the appendage body 152 to, for example, facilitate attachment of the mounting bracket 100 to the seed tube 110, as explained below. In such embodiments, a lower end of the support body 120 may be wider than an upper end of the support body 120. In the embodiment shown in FIG. 1, each of the main body 150 and the appendage body 152 includes a rectangular shape, though other shapes including square and elliptical are contemplated. As shown, the main body 150 and the appendage body 152 are connected together such that the support body 120 is substantially planar. In some embodiments, the main and appendage bodies may be formed integrally together, such as being formed from the same stock material. Bodies of other shapes may be suitable, including those where the first and second longitudinal edge 130, 132 are at least partially non-linear and/or where the support body 120 is at least partially curved. In one embodiment, the support body 120 may include a thickness that is substantially less than its length or its width such that the support body 120 may be considered to have a thin profile. In short, the support body 120 can be modified to accommodate different planters and different seed tubes and the discussion of any particular embodiment is meant as illustrative only. As explained in more detail below, the size and shape of the support body 120 may provide, in combination with the adjustment mechanism 102, a desired aesthetic and/or functional characteristic of the mounting bracket 100.

Referring back to FIGS. 1-4, to connect the seed tube 110 to the frame rail 106, the mounting bracket 100 may include first and second attachment members 160, 162 connected to the support body 120, such as to the same one of the front and rear faces 122, 124 of the support body 120 (e.g., the front face 122). As described herein, the first and second attachment members 160, 162 function to secure the mounting bracket 100 to the seed tube 110 and to the frame rail 106 of the seed planter 104. As shown, each of the first and second attachment members 160, 162 may be a hollow cylinder or sleeve configured to rotatably receive a fastener therein to connect the seed tube 110 to the frame rail 106 of the row unit 108. For example, each of the first and second attachment members 160, 162 may include a bore 164, 166, respectively, defined therethrough. Each bore 164, 166 may include a circular cross-section, though other cross-sectional shapes are contemplated, including elliptical and polygonal. In such embodiments, each of the first and second attachment members 160, 162 functions not only to connect the mounting bracket 100 to the seed tube 110 and the seed planter 104, but also as a hinge. Though illustrated as a sleeve, each of the first and second attachment members 160, 162 may take on substantially any form operable to connect the mounting bracket 100 to both the seed tube 110 and the frame rail 106 of the seed planter 104, such as apertures defined within the support body 120, corresponding retention features, or the like.

In one embodiment, each of the first and second attachment members 160, 162 may be connected to the support body 120 substantially transverse to the support body's longitudinal length L, such as along the transverse width W of the support body 120. As illustrated, the first attachment member 160 may be connected to the support body 120 adjacent the first end 126, such as to the appendage body 152. In such embodiments, the second attachment member 162 may be connected to the support body 120 (e.g., to the main body 150 of the support body 120) a distance away from the first end 126 and towards the second end 128. Depending on the particular attachment characteristics of the mounting bracket 100, the second attachment member 162 may be positioned nearer one of the first and second ends 126, 128 of the support body 120 (e.g., nearer the first end 126). For example, without limitation, the distance between the first and second attachment members 160, 162 may be between about 1 inch and about 3 inches, such as about 1 ¾ inches. The distance between the first and second attachment members 160, 162 may be customized based on the characteristics of the frame rail 106. For example, frame rails 106 of different manufacturers may vary in size, shape, and attachment characteristics. In such embodiments, the mounting bracket 100 may be configured, whether in the field or during manufacturing, based on the characteristics of the particular frame rail 106. For example, as explained below, the first and second attachment members 160, 162 may be positioned along the support body 120 to correspond with existing connection mechanisms (e.g., apertures) defined within the frame rail 106.

Continuing to refer to FIGS. 1-4, the adjustment mechanism 102 may include features operable to connect the mounting bracket 100 to frame rails 106 of various shapes and sizes. For example, the adjustment mechanism 102 of the present disclosure is configured to move towards or away from the support body 120 to account for frame rails 106 of different heights. As one example, the adjustment mechanism 102 adjusts the distance between a portion of the adjustment mechanism 102 and at least one of the first and second attachment members 160, 162. In this manner, the adjustment mechanism 102 is operable to change the effective length of the mounting bracket 100, such that a portion of the frame rail 106 is captured between the adjustment mechanism 102 and at least one of the first and second attachment members 160, 162 to secure the mounting bracket 100 to the frame rail 106. The adjustment mechanism 102 may be connected to one of the first and second ends 126, 128 of the support body 120, such as to the second end 128. In at least one embodiment, the adjustment mechanism 102 may be attached to one of the front and rear faces 122, 124 of the support body 120 (e.g., the rear face 124). In some embodiments, the adjustment mechanism 102 may be attached to a face opposite that which the first and second attachment members 160, 162 are connected. Once connected to the support body 120, the adjustment mechanism 102 may extend substantially parallel to the longitudinal length L of the support body 120 to adjust the effective length of the mounting bracket 100, as detailed below.

The adjustment mechanism 102 in one embodiment includes an adjustment bolt 170 connected to the support body 120, an attachment plate 172 slidably coupled to the adjustment bolt 170, and an adjustment nut 174 coupled with, such as threadedly engaged with, the adjustment bolt 170. As explained below, the adjustment nut 174 may be operable to move the attachment plate 172 along the adjustment bolt 170 towards or away from the support body 120 to change an attachment dimension of the mounting bracket 100. In such embodiments, the attachment plate 172 may be configured to engage the frame rail 106 of the row unit 108, such as a bottom side of the frame rail 106. The attachment plate 172 may include a planar portion 176 and a pair of opposing clip members 178 extending from opposing ends of the planar portion 176. To slidably couple the attachment plate 172 to the adjustment bolt 170, an aperture 180 may be defined within the attachment plate 172, such as within the planar portion 176. In such embodiments, the adjustment bolt 170 may be received at least partially within the aperture 180, and the attachment plate 172 may be positioned between the adjustment nut 174 and the support body 120 of the mounting bracket 100. To limit removal of the attachment plate 172 from the adjustment bolt 170, the adjustment nut 174 may include an outer diameter greater than the diameter of the aperture 180. As illustrated, each of the clip members 178 may curve towards the support body 120 of the mounting bracket 100 for engagement with the frame rail 106 of the row unit 108, as explained below. Though described and illustrated with reference to an adjustment bolt 170, an adjustment nut 174, and an attachment plate 172, one of skill in the art will understand that the adjustment mechanism 102 may take on substantially any form operable to adjust the effective length of the mounting bracket 100, including, without limitation, a sliding element and track, a non-threaded bolt and clip member, a rod and clevis pin, or the like.

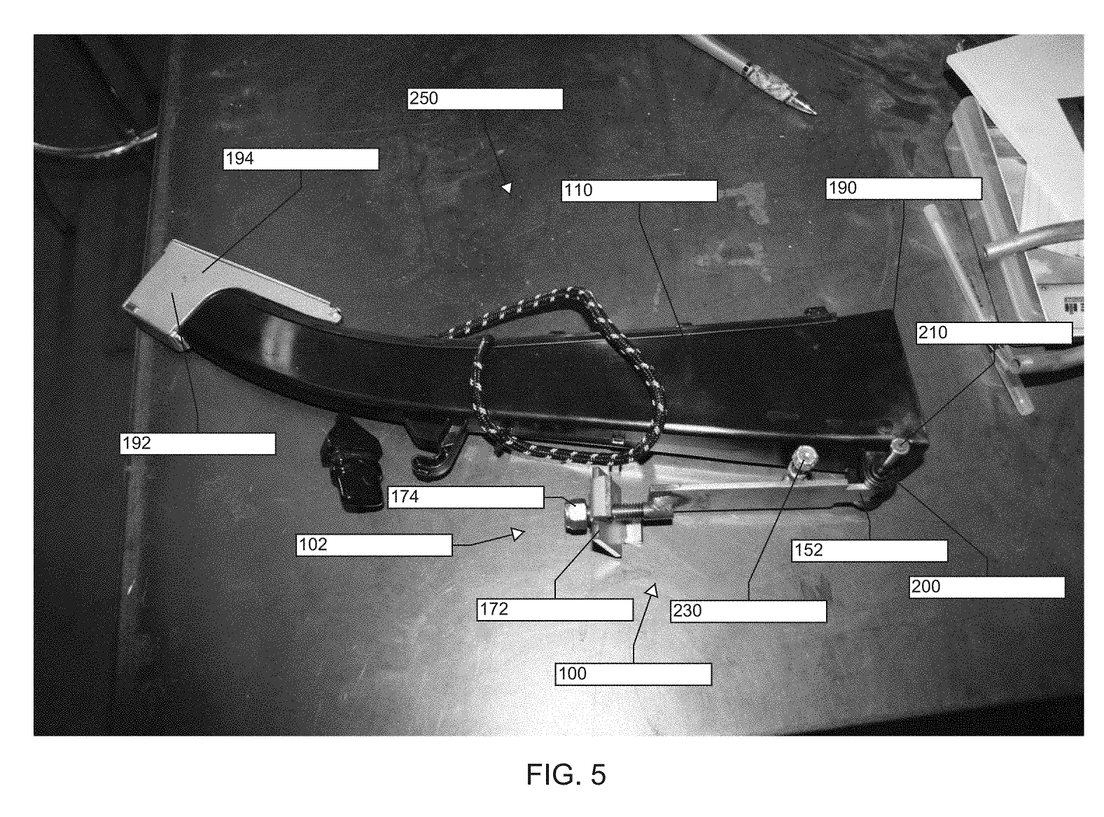

Referring to FIG. 5, the seed tube 110 may be a hollow member having an inlet 190 and an outlet 192. In some embodiments, the seed tube 110 may include a curve between its inlet 190 and outlet 192 such that the outlet 192 extends at an angle relative to the inlet 190. Additionally or alternatively, the seed tube 110 may taper in cross-section from the inlet 190 to the outlet 192 such that the inlet 190 includes a cross-sectional size greater than that of the outlet 192. The seed tube 110 is illustrated to include a polygonal (e.g., quadrilateral) cross-section, though it is contemplated the seed tube 110 may include substantially any cross-sectional shape, including circular, elliptical, etc. In some embodiments, the cross-sectional shape of the inlet 190 may be different than the cross-sectional shape of the outlet 192. For example, the inlet 190 may be shaped substantially rectangular in cross-section whereas the outlet 192 may be shaped substantially square in cross-section. In such embodiments, the seed tube 110 may taper smoothly between the different cross-sectional shapes to allow smooth passage of seeds passing therethrough. As shown, the seed tube 110 may include a seed sensor 194 configured to provide feedback to a user regarding the seeds passing through the seed tube 110 during planting operations. For example, the seed sensor 194 may be configured to sense the amount of seeds passing through the seed tube 110 as well as provide information regarding the consistency/uniformity of seed placement.

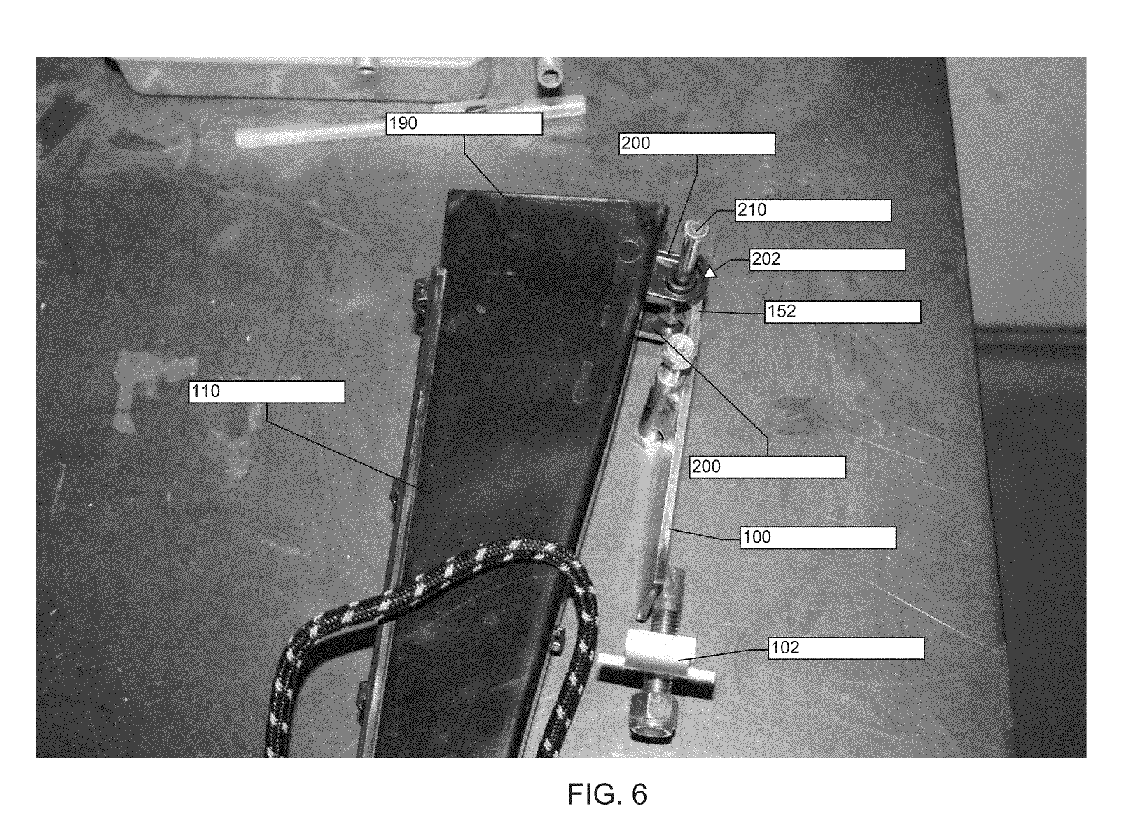

The seed sensor 194 may be positioned between the inlet 190 and the outlet 192 of the seed tube 110, such as adjacent the outlet 192. To connect the seed tube 110 to the seed planter 104, the seed tube 110 may include a pair of tabs 200 extending away from the seed tube 110 adjacent the inlet 190 for at least partial receipt of a portion of the mounting bracket 100 therebetween. In some embodiments, each of the tabs 200 may include an aperture 202 for attachment of the mounting bracket 100 to the seed tube 110, as explained below (see FIG. 6). The tabs 200 may extend substantially parallel to one another in a horizontally-spaced relationship. For example, the tabs 200 may be spaced apart a distance substantially equivalent to or greater than the width W_{A} of the appendage body 152 so at least a portion of the appendage body 152 of the support body 120 may be positioned between the tabs 200. In such embodiments, the difference in dimension between the respective widths W_{A}, W_{M} of the appendage body 152 and the main body 150 may account for the size of the tabs 200 such that the width W_{M} of the main body 150 corresponds to a distance between outer surfaces of the tabs 200.

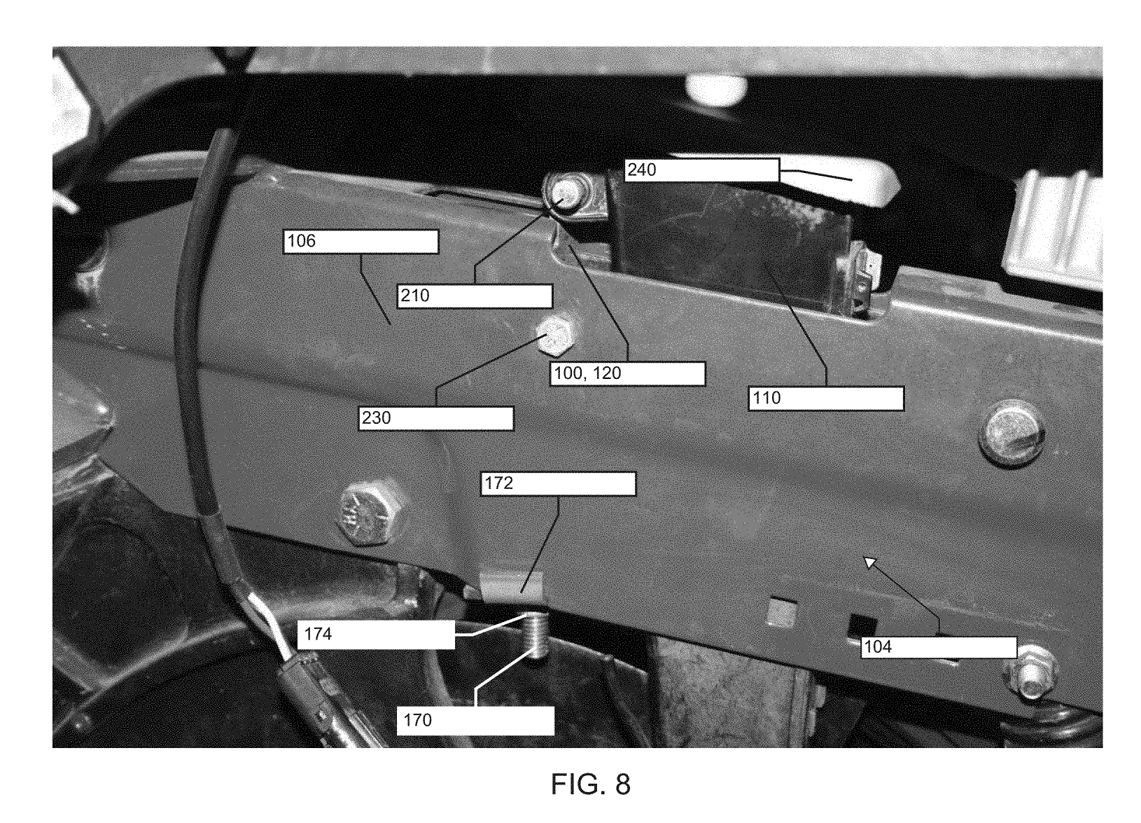

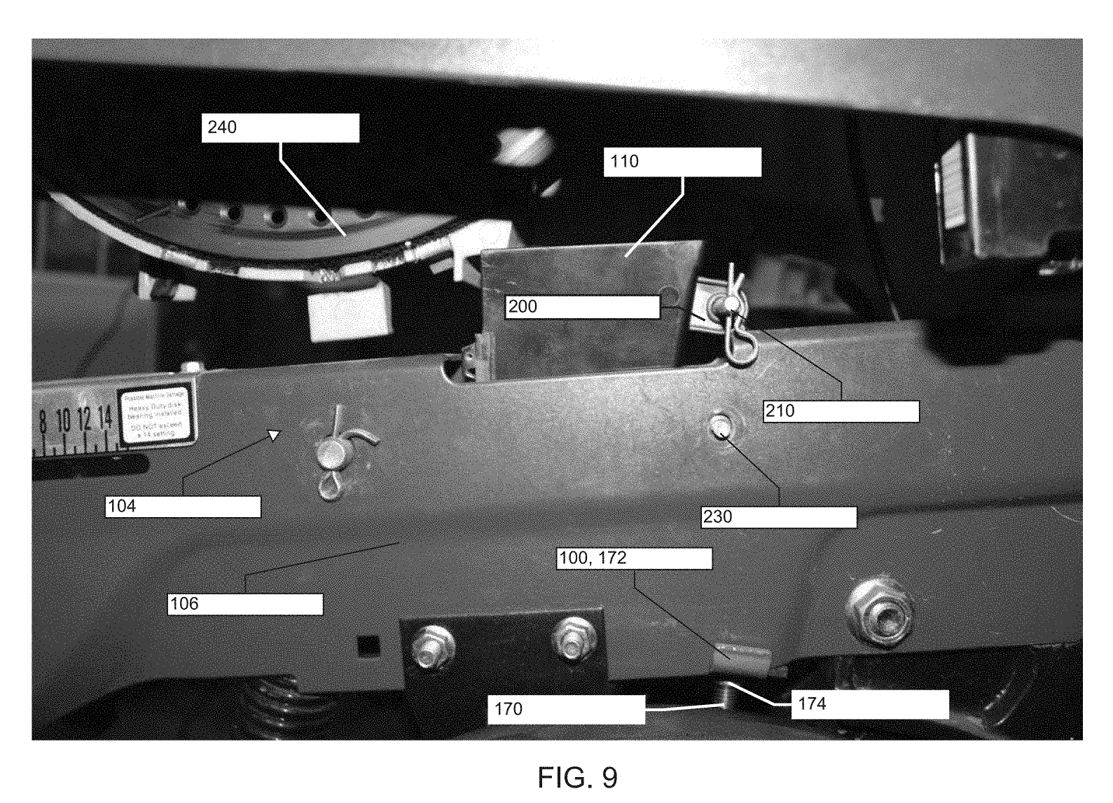

Referring to FIGS. 5-10, the mounting bracket 100 is used to connect the seed tube 110 to the frame rail 106 of the seed planter 104. With reference to FIGS. 5 and 6, to connect the mounting bracket 100 to the seed tube 110, a user may position the mounting bracket 100 adjacent the tabs 200 of the seed tube 110. For example, a user may position the appendage body 152 of the mounting bracket 100 adjacent the seed tube 110 such that the bore 164 of the first attachment member 160 is aligned concentrically with the apertures 202 of the tabs 200. Once aligned, a first fastener 210, which may be a pin, a bolt, or the like, may be inserted within the apertures 202 of the tabs 200 and within the bore 164 of the first attachment member 160 to connect the mounting bracket 100 to the seed tube 110. In some embodiments, the first fastener 210 may be rotatably received within the first attachment member 160 such that the seed tube 110 is pivotably coupled to the mounting bracket 100. In such embodiments, the seed tube 110 may pivot relative the mounting bracket 100 during seeding operations and/or to account for frame rails 106 of various sizes and configurations.

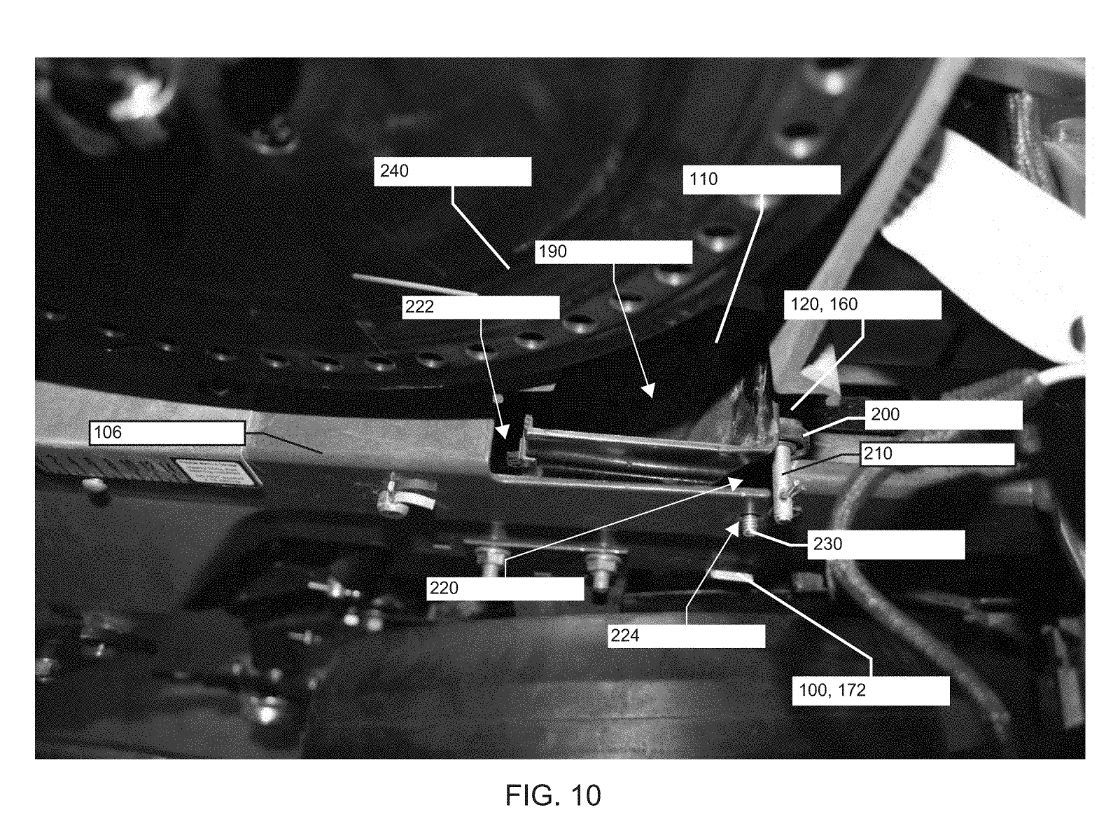

Referring to FIGS. 7-10, once the mounting bracket 100 is connected to the seed tube 110, the user may then attach the mounting bracket 100 to the frame rail 106 of the row unit 108. For example, without limitation, the mounting bracket 100 (e.g., the support body 120) may be sized and shaped to fit at least partially within the frame rail 106 of the seed planter 104. For instance, with reference to FIG. 10, the frame rail 106 may be at least partially boxed to define an interior cavity 220 of the frame rail 106. In some embodiments, the frame rail 106 may include a vertical channel 222 and a pair of aligned apertures 224 defined therethrough. Once attached, the seed tube 110 may extend through the channel of the frame rail 106, and the mounting bracket 100 may be connected to the frame rail 106 at least partially within the interior cavity 220 of the frame rail 106. In such embodiments, the mounting bracket 100, such as the support body 120, may be sized and shaped to fit within the interior cavity 220 of the frame rail 106. For example, the width(s) and/or length(s) of the support body 120 may be configured to substantially match or may be smaller than the interior dimensions of the interior cavity 220.

To attach the mounting bracket 100 to the frame rail 106, the seed tube 110 (including the mounting bracket 100) may be inserted within the channel defined in the frame rail 106 such that the mounting bracket 100 is received within the interior cavity 220 of the frame rail 106 of the seed planter 104. In such embodiments, the user may position a portion of the mounting bracket 100 (e.g., the main body 150 of the support body 120) within the interior cavity 220 of the frame rail 106 until the second attachment member 162 is substantially aligned with the aligned apertures 224 defined in the frame rail 106. Once aligned, a second fastener 230, which may be a pin, a bolt, or the like, may be inserted within the aligned apertures 224 of the frame rail 106 and within the bore 166 of the second attachment member 162 to connect the mounting bracket 100 to the frame rail 106. Like the description above in relation to the first attachment member 160, in some embodiments, the second fastener 230 may be rotatably received within the second attachment member 162 such that the mounting bracket 100 is pivotably coupled to the frame rail 106 to allow for movement during seeding operations and/or to account for frame rails 106 of various sizes and configurations.

As illustrated in FIGS. 7-10, when the mounting bracket 100 is connected to the frame rail 106, portions of the mounting bracket 100 may be positioned above and below the frame rail 106. For instance, at least a portion of the adjustment mechanism 102 (e.g., the attachment plate 172 and the adjustment nut 174) may be positioned below the frame rail 106. Additionally or alternatively, at least a portion of the appendage body 152 of the support body 120 (e.g., the first attachment member 160) may be positioned above the frame rail 106. In this manner, the seed tube 110 may be pivotably coupled to the mounting bracket 100 above the frame rail 106 of the row unit 108. In such embodiments, the mounting bracket 100 may be sized and shaped to position the seed tube 110 in alignment with other portions of the seed planter 104, such as a seed delivery mechanism 240 or meter positioned above the frame rail 106 of the row unit 108. When the seed tube 110 is connected to the frame rail 106 via the mounting bracket 100, seeds may be delivered to the seed tube 110 via the seed delivery mechanism 240 for proper operation of the seed planter 104.

In some embodiments, the adjustment mechanism 102 may be actuated to further secure the mounting bracket 100 to the frame rail 106. In particular, the adjustment nut 174 may be rotated about the adjustment bolt 170 in a first direction (e.g., clockwise) to move the adjustment nut 174 along the adjustment bolt 170 towards the support body 120 of the mounting bracket 100. As the adjustment nut 174 translates axially along the adjustment bolt 170 towards the support body 120, the attachment plate 172 is caused to move towards the support body 120 of the mounting bracket 100 to decrease an effective length (i.e., the attachment dimension) of the mounting bracket 100.

The attachment plate 172 may move towards the frame rail 106 until at least a portion of the attachment plate 172 engages the frame rail 106. As illustrated in at least FIG. 7, the planar portion 176 of the attachment plate 172 may contact the underside of the frame rail 106, with the clip members 178 capturing a portion of the frame rail 106 therebetween. For example, the width of the frame rail 106 adjacent the attachment plate 172 may be captured substantially between the clip members 178 to limit translational movement of the adjustment mechanism 102 relative the frame rail 106. In some embodiments, the engagement between the attachment plate 172 and the frame rail 106 may limit rotation of the mounting bracket 100 relative the frame rail 106 to at least maintain alignment of the seed tube 110 with the seed delivery mechanism 240. Though described as being first connected to the seed tube 110 before being connected to the frame rail 106, the mounting bracket 100 may be connected first to the frame rail 106 in some embodiments. In such embodiments, once the mounting bracket 100 is connected to the frame rail 106, the seed tube 110 may be inserted within the channel defined within the frame rail 106 and subsequently coupled with the first attachment member 160 of the mounting bracket 100.

In some embodiments, the mounting bracket 100 and the first and second fasteners 210, 230 may be included in a kit 250 (see FIGS. 1 and 5), which may provide alternative means for attaching a seed tube 110 to a seed planter 104. In some embodiments, the kit 250 may also include the seed tube 110, which may be included as part of the seed planter 104. The kit 250 may be provided with the seed tube 110 when shipped to a location for installation on the seed planter 104. As such, a first seed tube may be pre-installed on the frame rail 106 of the seed planter 104. If the initially-installed first seed tube is not desirable (e.g., the first seed tube includes a less than desirable seed sensor, provides inconsistent or undesirable seed spacing, exhibits less than desirable wearing characteristics, is broken, etc.), the first seed tube may be removed and replaced with another seed tube using the components supplied in the kit 250. In some embodiments, the mounting bracket 100 may be customized depending on a particular seed tube/seed planter combination. For example, the user or customer may desire to attach a seed tube to a previously incompatible seed planter, such as connecting a seed tube of one manufacturer to a seed planter of a different manufacturer or connecting a newer seed tube to an older seed planter not configured to receive the newer seed tube. In such embodiments, the mounting bracket 100 may be sized and shaped based on customer needs and existing equipment. For instance, in one exemplary embodiment, the kit 250 may include a mounting bracket 100 sized and shaped to connect a John Deere® seed tube to a Case® seed planter. The mounting bracket 100 may be sized and shaped to use existing mounting holes and/or locations within the frame rail 106 to attach the seed tube 110 to the seed planter 104. Depending on the particular seed tube 110 to seed planter 104 combination, the kit 250 may also include additional fasteners and/or components should other portions of the seed planter 104 need to be modified, replaced, and/or removed, such as the disc furrow mechanism and/or the shoe of the seed planter 104.

The mounting bracket 100 may be constructed of substantially any type of material. For example, the mounting bracket 100 may be constructed or formed from natural and/or synthetic materials, including metals, ceramics, plastics, and/or other suitable materials. Plastic materials may include thermoplastic material (self-reinforced or fiber-reinforced), ABS, polycarbonate, polypropylene, polystyrene, PVC, polyamide, or PTFE, among others. In some embodiments, the mounting bracket 100 may be formed of steel, aluminum, or any other metal. The mounting bracket 100 may be built, formed, molded, or non-molded in any suitable manner, such as by plug molding, blow molding, injection molding, milling, welding, or the like.

The foregoing description has broad application. It should be appreciated that the concepts disclosed herein may apply to many types of seed tube mounting brackets, in addition to the mounting brackets 100 described and depicted herein. Similarly, it should be appreciated that the concepts disclosed herein may apply to many types of seed planters, in addition to the seed planter 104 described and depicted herein. For example, the concepts may apply equally to any type of seed planter having a seed tube attached thereto for delivery of seeds into a furrow. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

The foregoing discussion has been presented for purposes of illustration and description and is not intended to limit the disclosure to the form or forms disclosed herein. For example, various features of the disclosure are grouped together in one or more aspects, embodiments, or configurations for the purpose of streamlining the disclosure. However, it should be understood that various features of the certain aspects, embodiments, or configurations of the disclosure may be combined in alternate aspects, embodiments, or configurations. Moreover, the following claims are hereby incorporated into this Detailed Description by this reference, with each claim standing on its own as a separate embodiment of the present disclosure.

The phrases “at least one”, “one or more”, and “and/or”, as used herein, are open-ended expressions that are both conjunctive and disjunctive in operation. The term “a” or “an entity”, as used herein, refers to one or more of that entity. As such, the terms “a” (or “an”), “one or more”, and “at least one” can be used interchangeably herein. All directional references (e.g., proximal, distal, upper, lower, upward, downward, left, right, lateral, longitudinal, front, back, top, bottom, above, below, vertical, horizontal, radial, axial, clockwise, and counterclockwise) are only used for identification purposes to aid the reader's understanding of the present disclosure, and do not create limitations, particularly as to the position, orientation, or use of this disclosure. Connection references (e.g., attached, coupled, connected, and joined) are to be construed broadly and may include intermediate members between a collection of elements and relative movement between elements unless otherwise indicated. As such, connection references do not necessarily infer that two elements are directly connected and in fixed relation to each other. Identification references (e.g., primary, secondary, first, second, third, fourth, etc.) are not intended to connote importance or priority, but are used to distinguish one feature from another. The drawings are for purposes of illustration only and the dimensions, positions, order and relative sizes reflected in the drawings attached hereto may vary.

What is claimed is:

1. A seed tube mounting bracket, comprising:
an elongate body including opposing first and second ends defining a longitudinal length of the body;
first and second attachment members connected to the body substantially transverse to the longitudinal length; and
an adjustment mechanism associated with the body to adjust an effective length of the mounting bracket.

2. The seed tube mounting bracket of claim 1, wherein:
the first attachment member is connected to the body adjacent the first end; and
the second attachment member is connected to the body a distance away from the first end towards the second end.

3. The seed tube mounting bracket of claim 2, wherein the second attachment member is positioned nearer the first end than the second end.

4. The seed tube mounting bracket of claim 1, wherein the adjustment mechanism includes:
an adjustment bolt connected to the body;
an attachment plate slidably coupled to the adjustment bolt; and
an adjustment nut threadedly engaged with the adjustment bolt to move the attachment plate towards or away from the body along the adjustment bolt.

5. The seed tube mounting bracket of claim 1, wherein each of the first and second attachment members is a hollow cylinder configured to rotatably receive a cylindrical fastener.

6. The seed tube mounting bracket of claim 1, wherein:
the body includes opposing front and rear faces; and
the first and second attachment members are attached to the same one of the front and rear faces of the body.

7. The seed tube mounting bracket of claim 6, wherein the adjustment mechanism is attached to the other of the front and rear faces of the body.

8. A kit for attaching a seed tube to a seed planter, the kit comprising:
a mounting bracket configured to connect the seed tube to a frame rail of the seed planter, the mounting bracket including first and second attachment members and an adjustment mechanism configured to adjust an effective length of the mounting bracket; and
first and second fasteners configured to be rotatably received within the first and second attachment members, respectively, wherein:
one of the first and second fasteners is operable to connect the mounting bracket to the seed tube; and
another of the first and second fasteners is operable to connect the mounting bracket to the frame rail of the seed planter.

9. The kit of claim 8, wherein the adjustment mechanism allows the mounting bracket to be connected to frame rails of various sizes.

10. The kit of claim 8, wherein at least one of the first and second fasteners is a pin.

11. The kit of claim 8, wherein the mounting bracket is operable to attach a seed tube of one manufacturer to a seed planter of a different manufacturer.

12. A seed planter comprising:
a row unit including a frame rail;
a seed tube; and
an adjustable mounting bracket attaching the seed tube to the frame rail of the row unit.

13. The seed planter of claim 12, wherein the mounting bracket includes:
a body member;
a plurality of hollow attachment members attached to a face of the body member, each of the attachment members rotatably receiving a fastener to connect the seed tube to the frame rail of the row unit; and
an adjustment mechanism configured to connect the mounting bracket to frame rails of various sizes.

14. The seed planter of claim 13, wherein:
the seed tube is pivotably coupled to one of the attachment members of the mounting bracket;
the mounting bracket is pivotably coupled to the frame rail via another of the attachment members; and
a portion of the adjustment mechanism engages the frame rail of the row unit to limit rotation of the mounting bracket relative to the frame rail.

15. The seed planter of claim 13, wherein the adjustment mechanism includes:
an adjustment bolt connected to the body member;
an attachment plate slidably coupled to the adjustment bolt and configured to engage the frame rail of the row unit; and
an adjustment nut threadedly engaged with the adjustment bolt to move the attachment plate towards or away from the frame rail along the adjustment bolt.

16. The seed planter of claim 15, wherein the attachment plate moves towards or away from a bottom side of the frame rail of the row unit.

17. The seed planter of claim 12, wherein the seed tube is pivotably coupled to the mounting bracket above the frame rail of the row unit.

18. A method of attaching a seed tube to a seed planter, the method comprising:
pivotably connecting the seed tube to a first attachment member of a mounting bracket;
coupling the mounting bracket to a frame rail of the seed planter via at least a second attachment member of the mounting bracket; and
adjusting an effective length of the mounting bracket via an adjustment mechanism to account for frame rails of various sizes.

19. The method of claim 18, further comprising engaging a portion of the adjustment mechanism with the frame rail of the seed planter to rotatably secure the mounting bracket to the frame rail.

20. The method of claim 18, wherein adjusting the effective length of the mounting bracket includes sliding an attachment plate towards or away from the frame rail of the seed planter via an adjustment nut threadedly coupled to an adjustment bolt.
